(19) United States
(12) Patent Application Publication
(10) Pub. No.: US 2024/0085685 A1
(43) Pub. Date: Mar. 14, 2024

(54) BIOLOGICAL SPECIMEN DETECTION SYSTEM, MICROSCOPE SYSTEM, FLUORESCENCE MICROSCOPE SYSTEM, BIOLOGICAL SPECIMEN DETECTION METHOD, AND PROGRAM

(71) Applicant: SONY GROUP CORPORATION, TOKYO (JP)

(72) Inventors: TETSURO KUWAYAMA, TOKYO (JP); HIROKAZU TATSUTA, TOKYO (JP)

(21) Appl. No.: 18/246,340

(22) PCT Filed: Oct. 5, 2021
(86) PCT No.: PCT/JP2021/036810

§ 371 Date: Mar. 23, 2023

(30) Foreign Application Priority Data
Oct. 15, 2020 (JP) 2020-174032

(51) Int. Cl. G02B 21/36; G01N 21/27; G01N 21/64; G02B 21/06

(52) U.S. Cl. CPC G02B 21/365; G01N 21/27; G01N 21/64; G02B 21/06; G01N 2201/10; G01N 2201/121; G02B 2207/113

(57) ABSTRACT

Suppressing deterioration in analysis accuracy on an image. A biological specimen detection system includes: a stage (20) capable of supporting a sample including a biological specimen; an observation system (40) that includes an objective lens (44) and observes the sample in a line-shaped visual field that is a part of a visual field through the objective lens; a signal acquisition unit (1) that acquires an image signal obtained from the sample by scanning the observation system in a first direction orthogonal to the line-shaped visual field; and a correction unit (24) that corrects distortion of a captured image based on the image signal on a basis of a positional relationship between an optical axis center of the objective lens and the line-shaped visual field.

### FIELD

The present disclosure relates to a biological specimen detection system, a microscope system, a fluorescence microscope system, a biological specimen detection method, and a program.

### BACKGROUND

There have been various image diagnosis methods using fluorescent staining proposed as methods excellent in quantitativity and poly-chromatism (refer to Patent Literature 1, for example). The fluorescence technique is advantageous in that multiplexing is easier than colored staining and detailed diagnostic information can be obtained. Even in fluorescence imaging other than pathological diagnosis, an increase in the number of colors makes it possible to collectively examine various antigens expressed in a sample.

### CITATION LIST

### Patent Literature

Patent Literature 1: JP 4452850 B2
Patent Literature 2: WO 2019/230878 A

### Non Patent Literature

Non Patent Literature 1: Edward C. Stack, “Multiplexed immunohistochemistry, imaging, and quantitation: A review, with an assessment of Tyramide signal amplification, multispectral imaging and multiplex analysis”, Methods 70 (2014) 46-58

### SUMMARY

### Technical Problem

An observation optical system includes distortion aberration with various degrees of magnitude, leading to an occurrence of distortion in an image in an observation visual field. This has caused a problem of possible deterioration of image analysis accuracy.

The present disclosure has been made in view of the above, and aims to provide a biological specimen detection system, a microscope system, a fluorescence microscope system, a biological specimen detection method, and a program capable of suppressing analysis accuracy deterioration regarding an image.

### Solution to Problem

To solve the problems described above, a biological specimen detection system according to the present disclosure includes: a stage capable of supporting a sample including a biological specimen; an observation system that includes an objective lens and observes the sample in a line-shaped visual field that is a part of a visual field through the objective lens; a signal acquisition unit that acquires an image signal obtained from the sample by scanning the observation system in a first direction orthogonal to the line-shaped visual field; and a correction unit that corrects distortion of a captured image based on the image signal on a basis of a positional relationship between an optical axis center of the objective lens and the line-shaped visual field.

### BRIEF DESCRIPTION OF DRAWINGS

FIG. 1 is a schematic block diagram of a fluorescence observation device according to an embodiment of the present technology.

FIG. 2 is a view illustrating an example of an optical system in the fluorescence observation device.

FIG. 3 is a schematic view of a pathological specimen as an observation target.

FIG. 4 is a schematic view illustrating a state of line illumination applied to the observation target.

FIG. 5 is a diagram for describing a spectral data acquisition method in a case where the imaging element in the fluorescence observation device can be configured by a single image sensor.

FIG. 6 is a diagram illustrating wavelength characteristics of spectral data acquired in FIG. 5.

FIG. 7 is a diagram illustrating a spectral data acquisition method in a case where the imaging element includes a plurality of image sensors.

FIG. 8 is a conceptual diagram illustrating a scanning method of line illumination applied to the observation target.

FIG. 9 is a conceptual diagram illustrating three-dimensional data (x, y, λ) acquired by a plurality of line illuminations.

FIG. 10 is a view illustrating a configuration example of a wavelength of an excitation unit in the fluorescence observation device.

FIG. 11 is a schematic diagram illustrating another configuration example of a spectral imaging unit in the fluorescence observation device.

FIG. 12 is a flowchart illustrating an example of a procedure of processing executed in a processing unit in the fluorescence observation device.

FIG. 13A is a diagram illustrating distortion caused by a general lens and an imaging element.

FIG. 13B is a diagram illustrating distortion caused by a general lens and an imaging element.

FIG. 14 is a diagram illustrating distortion in line illumination.

FIG. 15 is a diagram illustrating distortion correction in a case where dislocation occurs in a photographic area in line illumination.

FIG. 16A is a schematic diagram illustrating a procedure of correcting distortion in line illumination.

FIG. 16B is a flowchart illustrating a procedure of correcting distortion in line illumination.

FIG. 17A is a schematic diagram illustrating a procedure of correcting distortion in line illumination.

FIG. 17B is a flowchart illustrating a procedure of correcting distortion in line illumination.

FIG. 18A is a schematic diagram illustrating a procedure of correcting distortion in line illumination.

FIG. 18B is a flowchart illustrating a procedure of correcting distortion in line illumination.

FIG. 19 is a view illustrating a screen of a display unit in the fluorescence observation device.

FIG. 20 is a view illustrating an example of a screen configuration of a setting region of an excitation unit in the display unit.

FIG. 21 is a diagram illustrating an example of a screen configuration of a detection setting region of a fluorescence spectrum originated from one line illumination in the display unit.

FIG. 22 is a diagram illustrating an example of a screen configuration of a detection setting region of a fluorescence spectrum originated from another line illumination in the display unit.

FIG. 23 is a schematic diagram conceptually illustrating a relationship between fluorescence spectrum data and a fluorescence image displayed on a display unit.

FIG. 24 is a flowchart illustrating a modification of a procedure of processing executed in the processing unit.

FIG. 25 is a flowchart illustrating another modification of the procedure of processing executed in the processing unit.

FIG. 26 is a schematic block diagram illustrating a modification of the fluorescence observation device.

FIG. 27 is a schematic block diagram illustrating another modification of the fluorescence observation device.

FIG. 28 is a diagram illustrating an example of a test pattern used for verification of an effect according to the present embodiment.

FIG. 29 is a diagram illustrating misalignment of two line scan images in a case where the present embodiment is not applied.

FIG. 30 is a diagram illustrating misalignment when geometric correction is performed on two line scan images.

FIG. 31 is a diagram illustrating the fact that application of the present embodiment has reduced misalignment of two line scan images.

### DESCRIPTION OF EMBODIMENTS

A preferred embodiment of the present disclosure will be described in detail hereinbelow with reference to the accompanying drawings. Note that redundant descriptions will be omitted from the present specification and the drawings by assigning the same reference signs to components having substantially the same functional configuration.

The present disclosure will be described in the following order.
0. Introduction
1. One embodiment
1.1. Overall configuration
1.2. Observation unit
1.3. Processing unit
1.4. Problems in application to line scanning
1.5. Outline of distortion correction according to present embodiment
1.6. Specific examples
1.7. Display unit
1.8. Verification result
1.9. Modifications
1.10. Summary

### 0. Introduction

As described above, there have been various conventional image diagnosis methods using fluorescent staining proposed as methods excellent in quantitativity and poly-chromatism. In typical fluorescence photography, excitation light of an absorption wavelength (excitation wavelength) of a dye is emitted, and the spectrum of the dye issued by this irradiation is selectively captured by a band pass filter. In the presence of a plurality of colors, the absorption wavelength (excitation wavelength) varies depending on the die, leading to employment of a photographic method by switching the filter for each dye. However, since both the absorption spectrum and the emission spectrum of the dye overlap in a broad range, staining a plurality of colors would excite a plurality of dyes excited at one excitation wavelength. Furthermore, fluorescence of a dye adjacent to the band pass filter leaks to cause color mixing. On the other hand, there is known a photographic method by performing time-division switching a wavelength of excitation light and a wavelength of fluorescence to be detected (for example, Non Patent Literature 1). However, this method has a problem that an increase in colors will linearly increase the time for photography. As an observation method conceivable in view of the above circumstances, there is proposed a fluorescence observation (fluorescence microscopy) method using a plurality of beams of excitation light and a plurality of slits (refer to, for example, Patent Literature 2). This method makes it possible to emit a large number of beams of excitation light at a time, enabling acquisition of fluorescence data obtained by all the excitations in one scan. At this time, line scanning is to be performed in different portions in the visual field of the observation optical system.

In this, however, an observation optical system includes distortion aberration with various degrees of magnitude, leading to an occurrence of distortion in an image in an observation visual field. The distortion is also referred to as barrel distortion or pincushion distortion, and the distortion changes such that the longer the distance from the center of the visual field, the greater the distortion. Therefore, in a case where an observation target is imaged by a scanning method, an image obtained by the scanning has distortion depending on a position, which has caused a problem of the possibility of deterioration in image analysis accuracy.

To handle this, the following embodiments are provided to make it possible to suppress the analysis accuracy deterioration in an image, for example, analysis accuracy deterioration in an image acquired by a scanning method.

### 1. One Embodiment

### 1.1. Overall Configuration

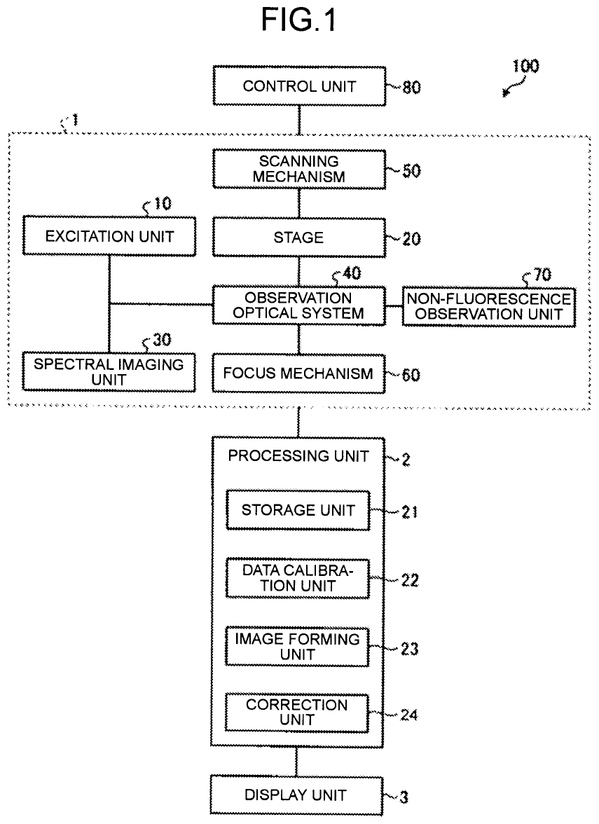

FIG. 1 is a block diagram illustrating a schematic configuration example of a fluorescence observation device according to an embodiment of the present disclosure. As illustrated in FIG. 1, a fluorescence observation device 100 includes an observation unit 1 and a processing unit 2. A stage 20 and a spectral imaging unit 30 in the observation unit 1, as well as the processing unit 2, can also be applied to a microscope system. A configuration in which an excitation unit 10 is added to the microscope system can also be applied to a fluorescence microscope system.

The observation unit 1 includes: an excitation unit 10 that irradiates a pathological specimen (pathological sample) with a plurality of line illuminations having different wavelengths and located in non-coaxial arrangement in parallel; a stage 20 that supports the pathological specimen; and a spectral imaging unit 30 that acquires a fluorescence spectrum (spectral data) of the pathological specimen excited as line-shaped illumination. That is, the observation unit 1 according to the present embodiment observes a pathological specimen by scanning a line-shaped visual field in a direction directly extending to the visual field. Note that the line-shaped visual field is not limited to a straight line, and may be curved.

Here, non-axial arrangement in parallel indicates the state including a plurality of line illuminations arranged non-axially in parallel. The state of non-axial means that the illuminations are not coaxial, with a distance between the axes not particularly limited. The term “parallel” is not limited to parallel in a strict sense, and includes a state of being substantially parallel. For example, the term permits distortion originated from an optical system such as a lens or deviation from a parallel state due to manufacturing tolerance, and the cases of these are also regarded as parallel.

The fluorescence observation device 100 further includes the processing unit 2. Based on the fluorescence spectrum of the pathological specimen (hereinafter, it is also referred to as a sample S) of a biological specimen acquired by the observation unit 1, the processing unit 2 typically forms an image of the pathological specimen or outputs a distribution of the fluorescence spectrum. The image referred to herein refers to an image converted into red, green, and blue (RGB) colors from a constituent ratio or a waveform regarding dyes constituting the spectrum or autofluorescence originated from the sample, or refers to a luminance distribution in a specific wavelength band, and the like.

The excitation unit 10 and the spectral imaging unit 30 are connected to the stage 20 via an observation optical system 40 such as an objective lens 44. The observation optical system 40 has a function of optimum focus tracking by using a focus mechanism 60. The observation optical system 40 may be connected to a non-fluorescence observation unit 70 for dark field observation, bright field observation, or the like.

The fluorescence observation device 100 may be connected to a control unit 80 that controls an excitation unit (LD/shutter control), an X-Y stage which is a scanning mechanism, a spectral imaging unit (camera), a focus mechanism (a detector and a Z stage), a non-fluorescence observation unit (camera), and the like. In the present embodiment, a plane (X-Y plane) on which the X-Y stage moves is to be a scanning plane scanned by the scanning mechanism.

The excitation unit 10 includes a plurality of light sources L1, L2, . . . that can output light of a plurality of excitation wavelengths Ex1, Ex2, . . . . The plurality of light sources is typically configured with a light emitting diode (LED), a laser diode (LD), a mercury lamp, and the like, and light from each device is emitted as line illumination and applied to the sample S of the stage 20.

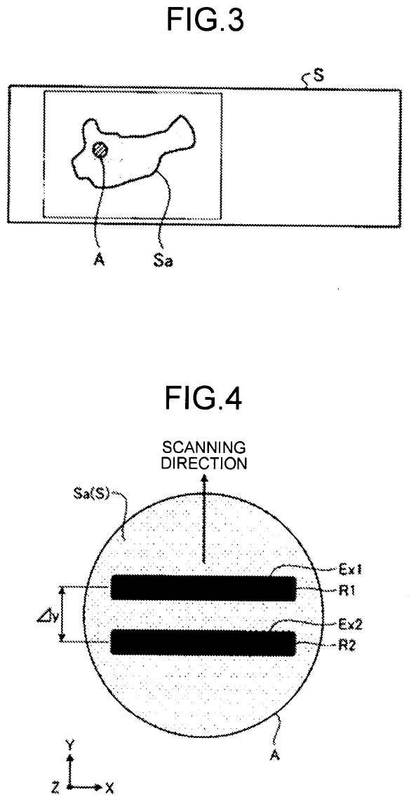

The sample S is typically composed of a slide including an observation target Sa such as a tissue section as illustrated in FIG. 3, but it is needless to say that the sample S may be composed of others. The sample S (observation target Sa) is stained with a plurality of fluorescent dyes. The observation unit 1 magnifies and observes the sample S at a desired magnification. In an enlarged view of a portion in A of FIG. 3, a plurality of line illuminations (two in the illustrated example (Ex1 and Ex2)) is disposed in as an illuminator as illustrated in FIG. 4, with photographic areas R1 and R2 of the spectral imaging unit 30 being arranged to overlap with the respective illumination areas. The two line illuminations Ex1 and Ex2 are individually parallel to the Z-axis direction, and are disposed away from each other by a predetermined distance (Δy) in the Y-axis direction.

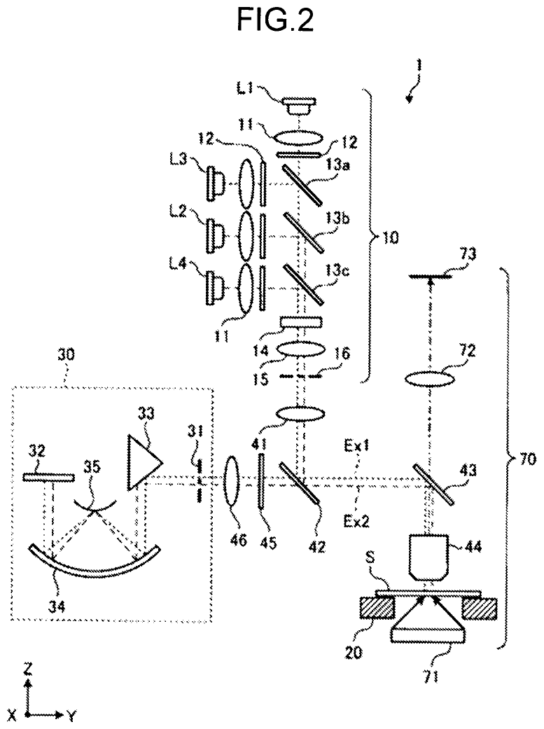

The photographic areas R1 and R2 individually correspond to slit parts of an observation slit 31 (FIG. 2) in the spectral imaging unit 30. Each slit may be a rectangular region elongated in a direction perpendicular to the scanning direction. That is, the number of slit parts arranged in the spectral imaging unit 30 is the same as the number of line illuminations. In FIG. 4, the line width of the illumination is wider than the slit width, although the magnitude relationship may be either relationship. When the line width of the illumination is larger than the slit width, it is possible to increase an alignment margin of the excitation unit 10 with respect to the spectral imaging unit 30. In the case of fluorescence observation with a single excitation light, for example, the observation slit 31 may be omitted. In that case, a plurality of region images may be generated by clipping a region corresponding to the photographic area R1 or R2 from the image acquired by the spectral imaging unit 30.

The wavelength forming a first line illumination Ext and the wavelength forming a second line illumination Ex2 are different from each other. The line-shaped fluorescence excited by the line illuminations Ext and Ex2 is observed in the spectral imaging unit 30 via the observation optical system 40.

The spectral imaging unit 30 includes: an observation slit 31 having a plurality of slit parts that allows the passage of the fluorescence excited by a plurality of line illuminations; and at least one imaging element 32 capable of individually receiving the fluorescence passing through the observation slit 31. The imaging element 32 can be constituted by employing a two-dimensional imager such as a Charge Coupled Device (CCD) and a Complementary Metal Oxide Semiconductor (CMOS). With the observation slit 31 disposed on the optical path, the fluorescence spectra excited in the respective lines can be detected without overlapping.

The spectral imaging unit 30 acquires, from each of the line illuminations Ex1 and Ex2, spectral data (x, λ) of fluorescence using a pixel array in one direction (for example, a vertical direction) of the imaging element 32 as a channel of a wavelength. The obtained spectral data (x, λ) is recorded in the processing unit 2 in a state where the spectral data is associated with excitation wavelength as origination of the spectral data.

The processing unit 2 can be implemented by hardware elements used in a computer, such as a central processing unit (CPU), random access memory (RAM), and read only memory (ROM), and necessary software. Instead of or in addition to the CPU, a programmable logic device (PLD) such as a field programmable gate array (FPGA), a digital signal processor (DSP), an application specific integrated circuit (ASIC), or the like may be used.

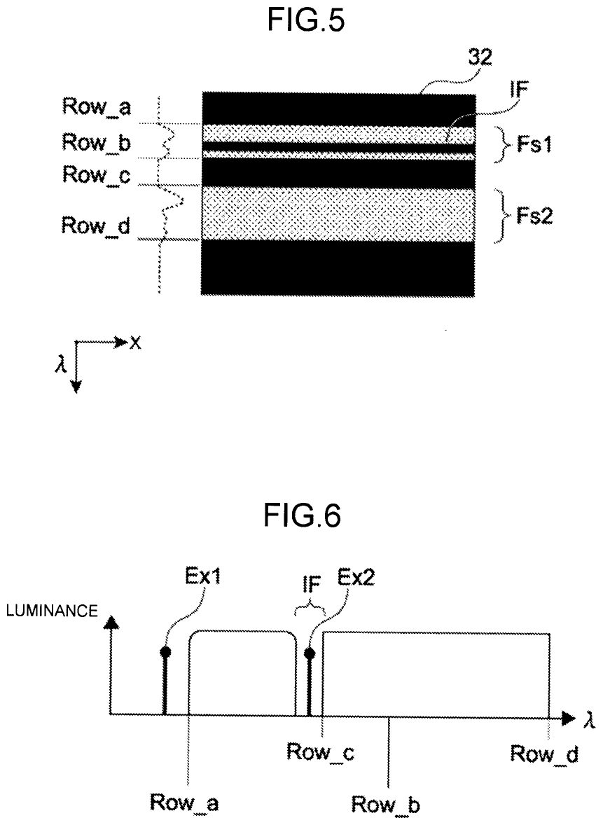

The processing unit 2 includes a storage unit 21 that stores spectral data indicating the correlation between the wavelengths of the plurality of line illuminations Ex1 and Ex2 and the fluorescence received by the imaging element 32. The storage unit 21 uses a storage device such as nonvolatile semiconductor memory or a hard disk drive, and stores in advance a standard spectrum of autofluorescence related to the sample S and a standard spectrum of a single dye to stain the sample S. For example, the spectral data (x, λ) obtained by light reception by the imaging element 32 is acquired as illustrated in FIGS. 5 and 6 and stored in the storage unit 21. In the present embodiment, the storage unit that stores the autofluorescence of the sample S and the standard spectrum of the single dye and the storage unit that stores the spectral data (measurement spectrum) of the sample S acquired by the imaging element 32 are actualized by the same storage unit 21. The storage unit is not limited thereto, and may be actualized by separate storage units.

FIGS. 5 and 6 are diagrams illustrating a spectral data acquisition method in a case where the imaging element 32 includes a single image sensor that commonly receives fluorescence having passed through the observation slit 31. In this example, fluorescence spectra Fs1 and Fs2 excited by the line illuminations Ex1 and Ex2 respectively are finally imaged on a light receiving surface of the imaging element 32 in a state of being shifted by an amount proportional to Δy (refer to FIG. 4) via the spectroscopic optical system (described below). As illustrated in FIG. 5, information obtained from the line illumination Ex1 is recorded as Row_a and Row_b, and information obtained from the line illumination Ex2 is recorded as Row_c and Row_d. Data other than these regions is not read out. This makes it possible to increase the frame rate of the imaging element 32 by Row full/(Row_b-Row_a×Row_d-Row_c) times the frame rate when readout is performed in a full frame.

As illustrated in FIG. 2, a dichroic mirror 42 and a band pass filter 45 are inserted in the middle of the optical path so as to prevent beams of the excitation light (Ex1 and Ex2) from reaching the imaging element 32. In this case, a non-continuous portion IF occurs in the fluorescence spectrum Fs1 that forms an image on the imaging element 32 (refer to FIGS. 5 and 6). Excluding such non-continuous portion IF from a readout region makes it possible to further improve the frame rate.

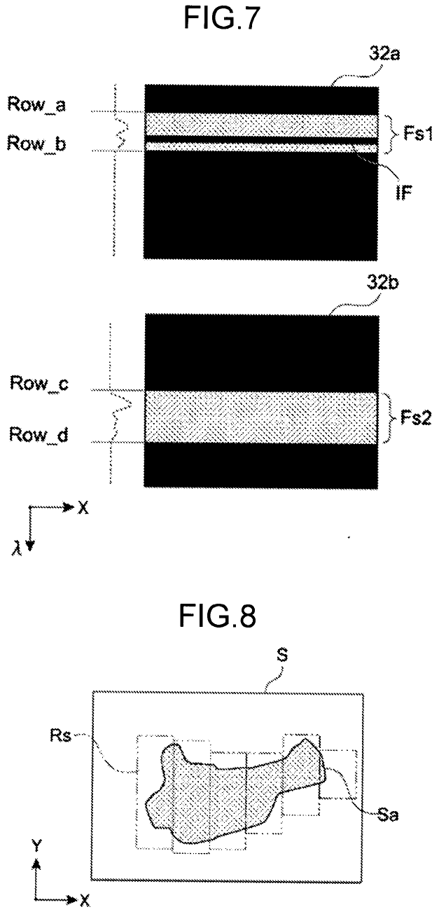

As illustrated in FIG. 2, the imaging element 32 may include a plurality of imaging elements 32a and 32b capable of receiving fluorescence that has passed through the observation slit 31, individually. In this case, the fluorescence spectra Fs1 and Fs2 respectively excited by the line illuminations Ex1 and Ex2 are acquired on the imaging elements 32a and 32b as illustrated in FIG. 7, and then stored in the storage unit 21 in association with the excitation light.

The line illuminations Ex1 and Ex2 are not limited to the configuration with a single wavelength, and each may have a configuration with a plurality of wavelengths. When each of the line illuminations Ex1 and Ex2 includes a plurality of wavelengths, the fluorescence excited by each of the line illuminations Ex1 and Ex2 also includes a plurality of spectra. In this case, the spectral imaging unit 30 includes a wavelength distribution element for separating the fluorescence into a spectrum originated from the excitation wavelength. The wavelength distribution element includes a diffraction grating, a prism, or the like, and is typically disposed on an optical path between the observation slit 31 and the imaging element 32.

The observation unit 1 further includes a scanning mechanism 50 that scans the stage 20 with the plurality of line illuminations Ex1 and Ex2 in the Y-axis direction, that is, in the arrangement direction of the line illuminations Ex1 and Ex2. With the scanning mechanism 50, spectra of the die (fluorescence spectra) spatially separated by Δy and excited at different excitation wavelengths on the sample S (observation target Sa) can be continuously recorded in the Y-axis direction. In this case, as illustrated in FIG. 8, for example, the photographic region Rs is split into a plurality of parts in the X-axis direction, and an operation of scanning the sample S in the Y-axis direction, then moving in the X-axis direction, and further performing scanning in the Y-axis direction is repeated. With a single scan, a spectral image originated from the sample excited by several excitation wavelengths can be obtained.

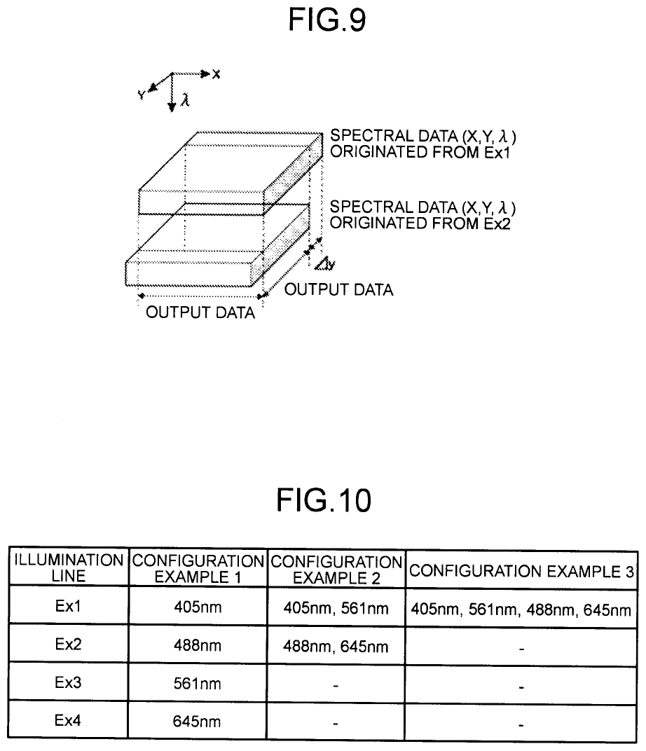

In the scanning mechanism 50, the stage 20 is typically scanned in the Y-axis direction. Alternatively, scanning may be performed in the Y-axis direction with a plurality of line illuminations Ex1 and Ex2 by a galvanometer mirror disposed in the middle of the optical system. Finally, three-dimensional data of (X, Y, λ) as illustrated in FIG. 9 is acquired for each of the plurality of line illuminations Ex1 and Ex2. The three-dimensional data originated from each of the line illuminations Ex1 and Ex2 is data whose coordinates are shifted by Δy with respect to the Y-axis, and thus is corrected and output on the basis of a value Δy recorded in advance or a value Δy calculated from the output of the imaging element 32.

Although the above example uses two line illuminations as the excitation light beam, the number of line illuminations as the excitation light beam may be three, four, or five or more, not limited to two. In addition, each line illumination may include a plurality of excitation wavelengths selected to suppress degradation of color separation performance as much as possible. In addition, even with one line illumination, by using the excitation light source formed with a plurality of excitation wavelengths and recording the individual excitation wavelengths in association with Row data obtained by the imaging element, it is still possible to obtain a polychromatic spectrum although it is not possible to obtain separability equal to the case using non-axial parallel beams. For example, a configuration as illustrated in FIG. 10 may be adopted.

### 1.2. Observation Unit

Next, details of the observation unit 1 will be described with reference to FIG. 2. Here, an example in which the observation unit 1 is configured with the configuration example 2 in FIG. 10 will be described. The observation unit 1 functions as an imaging unit (also referred to as a signal acquisition unit) as a whole. Note that the image signal acquired by the observation unit 1 may be a fluorescence signal or may include an image signal and a fluorescence signal.

The excitation unit 10 includes a plurality of (four in the present example) excitation light sources L1, L2, L3, and L4. Each of the excitation light sources L1 to L4 includes a laser light source that outputs laser light having a wavelength of 405 nm, 488 nm, 561 nm, and 645 nm, respectively.

The excitation unit 10 further includes: a plurality of collimator lenses 11 and a plurality of laser line filters 12 each of which corresponding to the respective excitation light sources L1 to L4; dichroic mirrors 13a, 13b, and 13c; a homogenizer 14; a condenser lens 15; and an incident slit 16. The laser light emitted from the excitation light source L1 and the laser light emitted from the excitation light source L3 are collimated by the collimator lens 11, transmitted through the laser line filter 12 for cutting out-of-band components of each wavelength band, and is formed into a coaxial beam by the dichroic mirror 13a. The two coaxial laser beams undergoes further beam-shaping by the homogenizer 14 such as a fly-eye lens and the condenser lens 15 so as to be the line illumination Ext.

Similarly, the laser light emitted from the excitation light source L2 and the laser light emitted from the excitation light source L4 are formed into a coaxial beam by the dichroic mirrors 13b and 13c so as to be the line illumination, namely, the line illumination Ex2 which is non-coaxial to the line illumination Ext. The line illuminations Ext and Ex2 form non-coaxial line illumination (primary image) separated by Δy in the incident slit 16 (slit conjugate) having a plurality of slit parts each permitting the passage of each of the line illumination Ex1 and Ex2.

The sample S on the stage 20 is irradiated with the primary image through the observation optical system 40. The observation optical system 40 includes a condenser lens 41, dichroic mirrors 42 and 43, an objective lens 44, a band pass filter 45, and a condenser lens 46. The line illuminations Ext and Ex2 are collimated by the condenser lens 41 paired with the objective lens 44, reflected by the dichroic mirrors 42 and 43, transmitted through the objective lens 44, and applied to the sample S.

The illumination as illustrated in FIG. 4 is formed on the surface of the sample S. The fluorescence excited by these illuminations is condensed by the objective lens 44, reflected by the dichroic mirror 43, transmitted through the dichroic mirror 42 and the band pass filter 45 that cuts off the excitation light, condensed again by the condenser lens 46, and incident on the spectral imaging unit 30.

The spectral imaging unit 30 includes an observation slit 31, imaging elements 32 (32a and 32b), a first prism 33, a mirror 34, a diffraction grating 35 (wavelength distribution element), and a second prism 36.

The observation slit 31 is disposed at the focal point of the condenser lens 46 and has the same number of slit parts as the number of excitation lines. The fluorescence spectra originated from the two excitation lines that have passed through the observation slit 31 are separated by the first prism 33 and reflected by the grating surface of the diffraction grating 35 via the mirror 34, so as to be further separated into fluorescence spectra of individual excitation wavelengths. The four fluorescence spectra thus separated are incident on the imaging elements 32a and 32b via the mirror 34 and the second prism 36, and developed into (x, λ) information as spectral data.

The pixel size (nm/Pixel) of the imaging elements 32a and 32b is not particularly limited, and is set to 2 nm or more and 20 nm or less, for example. This variance value may be achieved optically or by setting a pitch of the diffraction grating 35, or may be achieved by using hardware binning of the imaging elements 32a and 32b.

The stage 20 and the scanning mechanism 50 constitute an X-Y stage, and cause the sample S to move in the X-axis direction and the Y-axis direction in order to acquire a fluorescence image of the sample S. In whole slide imaging (WSI), an operation of scanning the sample S in the Y-axis direction, then moving the sample S in the X-axis direction, and further performing scanning in the Y-axis direction is repeated (refer to FIG. 8).

The non-fluorescence observation unit 70 includes a light source 71, a dichroic mirror 43, an objective lens 44, a condenser lens 72, an imaging element 73, and the like. In the non-fluorescence observation system, FIG. 2 illustrates an observation system by dark field illumination.

The light source 71 is disposed below the stage 20, and irradiates the sample S on the stage 20 with illumination light from the side opposite to the line illuminations Ex1 and Ex2. In the case of dark field illumination, the light source 71 illuminates from the outside of the numerical aperture (NA) of the objective lens 44, and the light (dark field image) diffracted by the sample S is photographed by the imaging element 73 via the objective lens 44, the dichroic mirror 43, and the condenser lens 72. By using dark field illumination, even an apparently transparent sample such as a fluorescently-stained sample can be observed with contrast.

Note that this dark field image may be observed simultaneously with fluorescence and used for real-time focusing. In this case, the illumination wavelength can be determined by selecting a wavelength that would not affect fluorescence observation. Not limited to the observation system that acquires the dark field image, the non-fluorescence observation unit 70 may include an observation system that can acquire a non-fluorescence image such as a bright field image, a phase difference image, a phase image, and an in-line hologram image. For example, examples of an applicable method of acquiring a non-fluorescence image include various observation methods such as a Schlieren method, a phase difference contrast method, a polarization observation method, and an epi-illumination method. The illumination light source need not be located below the stage, and may be located above the stage or around the objective lens. Furthermore, not only a method of performing focus control in real time, but also another method such as a pre-focus map method of recording focus coordinates (Z coordinates) in advance may be adopted.

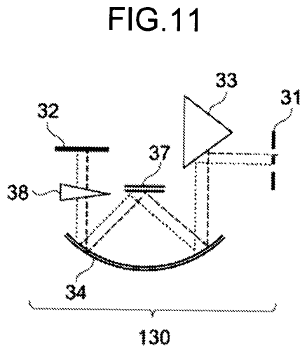

FIG. 11 is a schematic diagram illustrating another configuration example of the spectral imaging unit. A spectral imaging unit 130 illustrated in the drawing includes a single imaging element 32. Each fluorescence passing through the observation slit 31 having the slit portions corresponding to the number of excitation lines is reimaged on the imaging element 32 via a relay optical system (first prism 33, mirrors 34 and 37) and the wavelength distribution element (prism or the like) 38 arranged in the middle of the relay optical system, and then, the fluorescence is developed into (x, λ) data (refer to FIG. 5). At this time, the value obtained by converting the excitation light interval Δy into pixels is determined so as not to allow the distributed spectra to overlap on the imaging element 32.

### 1.3. Processing Unit

The fluorescence spectrum acquired by the imaging element 32 (32a and 32b) is output to the processing unit 2. The processing unit 2 further includes: a storage unit 21; a data calibration unit 22 that calibrates spectral data stored in the storage unit 21; an image forming unit 23 that forms a fluorescence image of the sample S on the basis of the spectral data and the interval Δy between the plurality of line illuminations Ex1 and Ex2; and a correction unit 24 that corrects image distortion caused by the optical system.

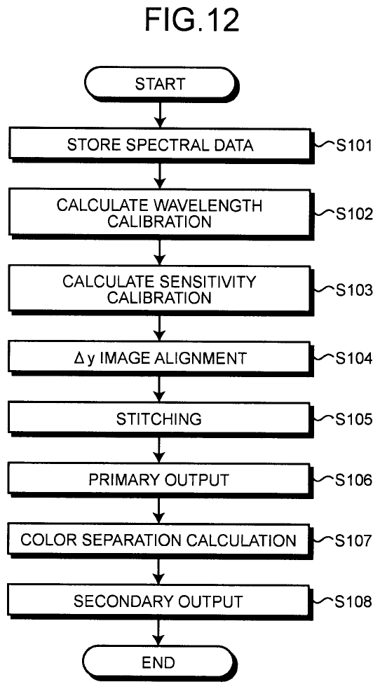

FIG. 12 is a flowchart illustrating an example of a procedure of processing executed in the processing unit 2.

The storage unit 21 stores the spectral data (fluorescence spectra Fs1 and Fs2 (refer to FIGS. 5 and 7)) acquired by the spectral imaging unit 30 (step S101). The storage unit 21 preliminarily stores autofluorescence related to the sample S and a standard spectrum of a single dye.

The storage unit 21 extracts only a wavelength region of interest from the pixel array in the wavelength direction of the imaging element 32, thereby improving the recording frame rate. The wavelength region of interest corresponds to, for example, a range of visible light (380 nm to 780 nm) or a wavelength range determined by an emission wavelength of a dye used to stain the sample.

Examples of the wavelength region other than the wavelength region of interest include a sensor region having light of an unnecessary wavelength, a sensor region having obviously no signal, and a region of an excitation wavelength to be cut off by the dichroic mirror 42 or the band pass filter 45 in the middle of the optical path. Furthermore, the wavelength region of interest on that sensor may be switched depending on the line illumination situation. For example, when the excitation wavelength area used for the line illumination is small, the wavelength region on the sensor is also limited, making it possible to increase the frame rate by the limited amount.

The data calibration unit 22 converts the spectral data stored in the storage unit 21 from the pixel data (x, λ) into a wavelength, and calibrates all the spectral data so as to be output after being complemented to a wavelength unit ([nm], [μm], etc.) having a common discrete value (step S102).

The pixel data (x, λ) is not necessarily neatly aligned in the pixel array of the imaging element 32, and is distorted, in some cases, due to slight inclination or distortion of the optical system. Therefore, for example, when a pixel is converted into a wavelength unit using a light source having a known wavelength, the data would be converted into a different wavelength (nm value) in all x coordinates. In this state, since handling of data is complicated, the data is converted into data aligned with integers by a complementation method (for example, linear complementation or spline complementation) (step S102).

Furthermore, there is a possibility of occurrence of uneven sensitivity in the longitudinal direction (X-axis direction) of the line illumination. The uneven sensitivity is generated by uneven illumination or the variation in the slit width, which leads to the uneven luminance in the photographic image. Therefore, in order to cancel the unevenness, the data calibration unit 22 performs output after performing homogenization using a certain light source and its representative spectrum (average spectrum or spectral radiance of the light source) (step S103). Homogenized illumination eliminates an individual difference between devices, making it possible, in the waveform analysis of the spectrum, to reduce time and effort for measuring each component spectrum every time. Furthermore, an approximate quantitative value of the number of fluorescent dyes can also be output from the luminance value subjected to sensitivity calibration.

When the spectral radiance [W/(sr·m²·nm)] is adopted for the calibrated spectrum, the sensitivity of the imaging element 32 corresponding to each wavelength is also corrected. Calibrating the spectrum to be the reference in this manner will eliminates the need to measure the reference spectrum used for the color separation calculation for each device. When the dye is stable in the same lot, the dye can be diverted by performing photography once. Furthermore, given the fluorescence spectrum intensity per molecule of dye in advance, it is possible to output an approximate value of the number of fluorescent dye molecules converted from the luminance value subjected to sensitivity calibration. This value is high in quantitativity because autofluorescence components are also separated.

The above processing is similarly executed for illumination ranges of the line illuminations Ex1 and Ex2 in the sample S scanned in the Y-axis direction. This makes it possible to obtain spectral data (x, y, λ) of each fluorescence spectrum for the entire range of the sample S. The obtained spectral data (x, y, λ) is stored in the storage unit 21.

The image forming unit 23 forms a fluorescence image of the sample S on the basis of the spectral data stored in the storage unit 21 (or the spectral data calibrated by the data calibration unit 22) and the interval corresponding to the inter-axis distance (Δy) of the excitation lines Ex1 and Ex2 (step S104). In the present embodiment, the image forming unit 23 forms, as the fluorescence image, an image in which the detection coordinates of the imaging element 32 have been corrected with a value corresponding to the interval (Δy) between the plurality of line illuminations Ex1 and Ex2.

The three-dimensional data originated from each of the line illuminations Ex1 and Ex2 is data whose coordinates are shifted by Δy with respect to the Y-axis, and thus is corrected and output on the basis of a value Δy recorded in advance or a value Δy calculated from the output of the imaging element 32. Here, the difference in detection coordinates in the imaging element 32 is corrected so that the three-dimensional data originated from each of the line illuminations Ex1 and Ex2 is to be data on the same coordinates.

The image forming unit 23 executes processing (stitching) for connecting the photographed images into one large image (WSI) (step S105). This makes it possible to acquire a pathological image related to the multiplexed sample S (observation target Sa). The formed fluorescence image is output to a display unit 3 (step S106).

Furthermore, based on the standard spectra of the autofluorescence and the single dye of the sample S stored in advance in the storage unit 21, the image forming unit 23 separately calculates the component distributions of the autofluorescence and the dye of the sample S from the spectral data obtained by photography (measurement spectrum). It is possible to adopt a calculation method such as a least squares method, or a weighted least squares method, in which a coefficient is calculated such that captured spectral data is a linear sum of the standard spectra. The calculated distribution of the coefficients is stored in the storage unit 21, output to the display unit 3 so as to be displayed as an image (steps S107 and S108). In this manner, the image forming unit 23 can also function as an analysis unit that analyzes photographed spectral data (measurement spectrum). However, the analysis of the spectral data (measurement spectrum) may be executed outside the fluorescence observation device 100 (for example, an external server such as a cloud server). In addition, the analysis of spectral data may include analysis of measurement accuracy of a measurement system that acquires spectral data, separation performance in separating a fluorescent component from spectral data, staining performance of a fluorescent reagent panel in fluorescent staining, and the like.

### 1.4. Problems in Application to Line Scanning

According to the above-described method, it is possible to emit a large number of beams of excitation light at a time, enabling acquisition of fluorescence data due to all the excitations in one scan. At this time, line scanning is to be performed in different portions in the visual field of the observation optical system. An observation optical system includes distortion aberration with various degrees of magnitude, leading to an occurrence of distortion in an image in an observation visual field. The distortion is also referred to as barrel distortion or pincushion distortion, and the distortion changes such that the longer the distance from the center of the visual field, the greater the distortion. Images obtained by line scanning at different positions in the visual field will be pictures having different distortions. That is, objects in the plurality of obtained images are not exactly aligned because they have distortions in different ways.

When an object is analyzed on the basis of a plurality of line scan images, it is important that images in the plurality of line scan images are perfectly aligned with each other. For example, when fluorescence signals excited at different wavelengths in each line scan are acquired and analyzed, the fluorescent dye is determined from the plurality of fluorescence signals. That is, the fluorescent dye cannot be correctly analyzed unless the fluorescence signal is obtained at each of a plurality of excitation wavelengths. In the line scan method in which a plurality of observation lines are set in the visual field as described above, there is a problem that each line scan image has various distortions, making it difficult to perform correct analysis in the analysis based on each line scan image.

### 1.5. Outline of Distortion Correction According to Present Embodiment

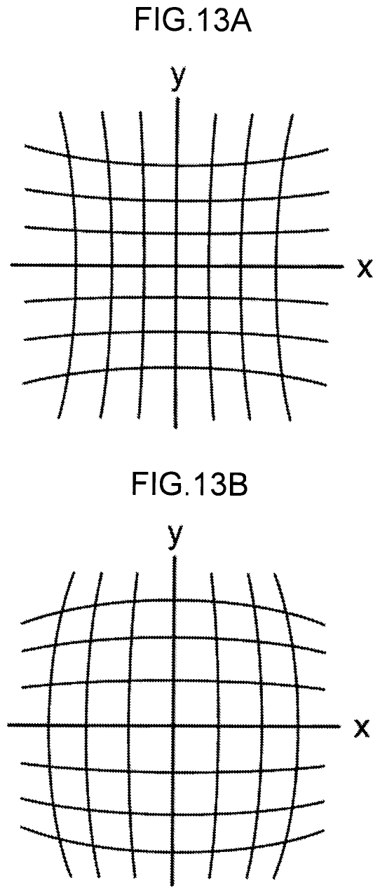

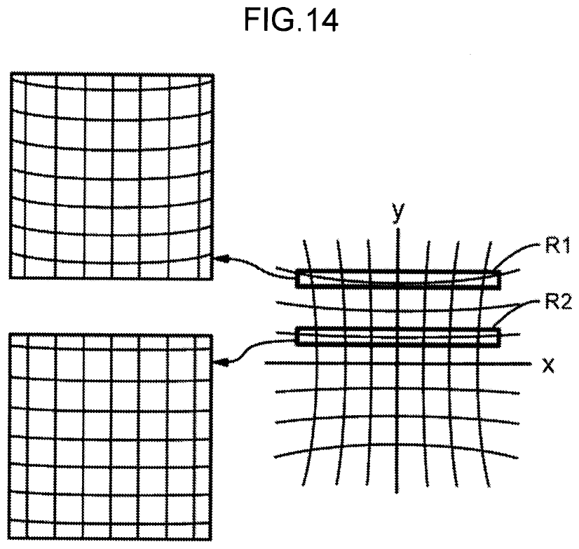

In order to solve the problem in the known technology, it is effective to apply image processing to the acquired image. Ordinary camera lens distortion is a conventionally known distortion (for example, FIGS. 13A and 13B). However, image distortion generated by the line scan in the imaging system with distortion is different from the image distortion attributed to normal distortion (for example, FIG. 14). This is because, since a part of the distorted image is clipped and scanned, how the distortion occurs differs depending on which part of the distorted visual field is clipped and scanned. In addition, regarding the scanning direction, almost no distortion occurs in a stage with high accuracy as used in a normal microscope because images are simply transferred by the stage. The distortion occurs as a coordinate shift depending on a position in a direction directly extending to the scanning direction.

There is a known correction formula for distortion in a normal camera lens. However, since distortion in the line scan is different from the distortion caused by the normal camera lens as described above, the known correction formula cannot be applied in an original form. In the distortion correction according to the present embodiment, a correction formula suitable for the line scan image will be proposed.

### 1.6. Specific Examples

In the present embodiment, the correction unit 24 corrects image distortion caused by the above-described optical system. Note that the image here is not limited to an image after the autofluorescence and the component distribution of the dye have been separately calculated by the image forming unit 23. The data may be spectral data acquired by the spectral imaging unit 30, data calibrated by the data calibration unit 22, or the like. Therefore, the procedure may be performed in any of the above steps.

Furthermore, the correction unit 24 may perform correction on the basis of a positional relationship between the optical center (also referred to as an optical axis) of the objective lens 44 and the photographic areas R1 and R2 included in the imaging unit.

Formulas for correcting image distortion caused by the optical system include the following known Formula (1).

x=k₁x′(1+k₂(x′²+y′²))

y=k₁y′(1+k₂(x′²+y′²)) (1)

Here, the x-axis direction and the y-axis direction are orthogonal coordinates including a plane of an imaging region, k1 is a coefficient of magnification of the optical system, and k2 is a coefficient contributing to substantial distortion.

FIG. 13A is an example of distortion in the case of k1=1 and k2=−0.01, which is distortion referred to as pincushion distortion. Furthermore, FIG. 13B is an example of distortion in a case of k1=1 and k2=0.01, which is distortion referred to as barrel distortion.

The distortion correction formula expressed by Formula (1) is based on the premise that the photographic area is a region having a width such as a rectangular region with the optical center of the optical system of the lens as the center of gravity and that the imaging target is to be photographed at one scan. In the present embodiment, the photographic areas R1 and R2 are line-shaped areas, and the entire image is generated by connecting the images photographed while changing the relative position between the stage and the imaging unit, so that the above mathematical expression cannot be directly applied.

In this case, for example, among the pincushion distortion represented by Formula (1) as illustrated in FIG. 13A, the distortion of the region corresponding to the photographic areas R1 and R2 of the present embodiment is repeated in the scanning direction, generating a distortion different for each photographic area as illustrated in FIG. 14.

It has been found that the distortion as illustrated in FIG. 14 can be appropriately removed by applying the following Formula (2) in the present embodiment.

x=c₁x′+c₂x′³

y=c₃y′+c₄x′² (2)

Here, the x direction is a line direction (extending direction of line illumination), the y direction is a direction of stage scan, c1 is a coefficient of magnification, c2 is a coefficient indicating a degree of distortion in the x direction depending on x, c3 is a coefficient related to stage scan for scanning on the X-Y stage, and c4 is a coefficient indicating a degree of distortion in the y direction depending on x. These pieces of information are also referred to as optical information. Note that c2 and c4 are values that change depending on how much the line of the line scan has been shifted from the center of the visual field, and c3 is a value that is to be c3=c1 when the data sampling interval is the same as the data pitch in the x direction, and c3=c1×2 when the sampling interval is twice.

From Formula (2), it is found that the correction of a cubic function depending on x′ is to be applied to the distortion in the x direction and that the correction of a quadratic function depending on x′ is to be applied to the distortion in the y direction. That is, the distortion can be cancelled by performing the correction according to these.

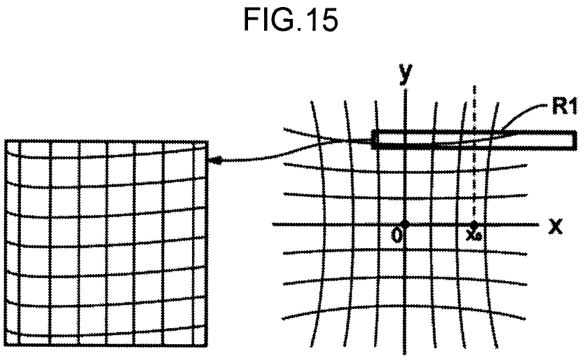

FIG. 15 illustrates a case where a plane that passes through the center of the photographic area R1 in the extending direction and is perpendicular to the extending direction of the photographic area R1 does not pass through the optical center of the lens and is shifted from the optical center by a distance x0. In this case, the correction formula expressed by Formula (2) needs to be corrected by the following Formula (3) by the shift amount x0.

x=c₁(x′−x₀)+c₂(x′−x₀)³

y=c₃y′+c₄(x′−x₀)² (3)

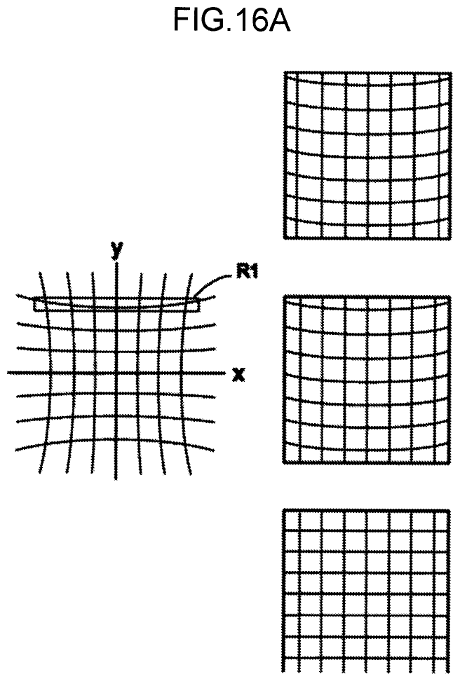

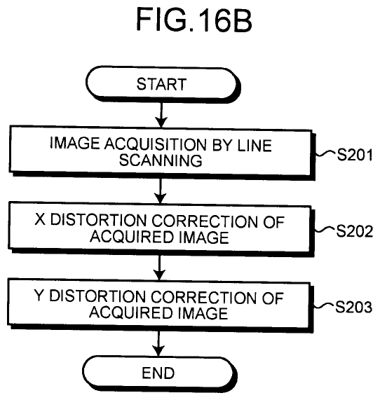

FIGS. 16A to 18B illustrate an example of a procedure of processing executed in the correction unit 24.

FIGS. 16A and 16B illustrate a basic correction flow of an image acquired by line scanning. The image acquired by line scanning has distortion in both the X direction (extending direction of the line illumination) and the Y direction (scanning direction) (step S201). The correction unit 24 corrects distortion in the X direction of the acquired image (step S202). The correction in the X direction is enlargement or reduction in the X direction depending on the X position. In enlargement/reduction, there are a method of obtaining a value by interpolation using a nearest neighbor value or linear interpolation from values of two points. Known enlargement or reduction methods in image processing include a nearest-neighbor method (a method of performing interpolation using a pixel value closest to a new pixel position among peripheral pixels) and bilinear interpolation (a method of linearly estimating a value from a peripheral pixel with respect to a new pixel position and performing interpolation). These methods, which are two-dimensional enlargement/reduction, can be used as a one-dimensional method. The correction in the Y direction uses a method of shifting the Y direction upward (or downward) depending on the X position (step S203). For these, it is conceivable to use the image processing method described above.

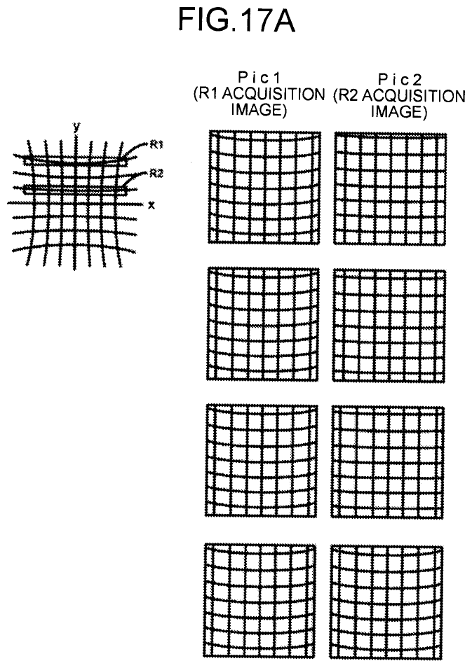

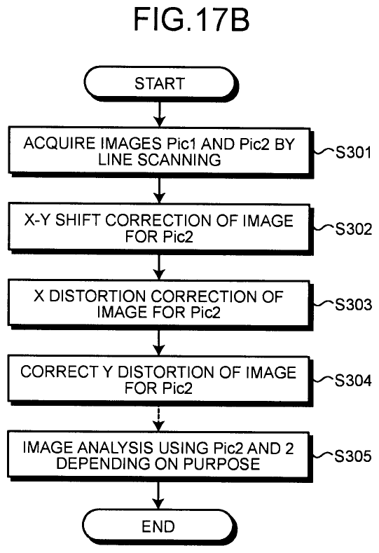

FIGS. 17A and 17B illustrate a flow of correcting an acquired image Pic2 acquired in the photographic area R2 with respect to an acquired image Pic1 acquired in the photographic area R1. Similarly to FIGS. 16A and 16B, an image acquired by line scanning has distortion in both the X direction (extending direction of the line illumination) and the Y direction (scanning direction) (step S301). In order to adapt the acquired image Pic2 to the image Pict, the correction unit 24 performs shift correction with respect to the X direction and the Y direction of the image Pic2 (step S302). At this time, the positional shift or the like of the imaging device corresponding to the photographic area R2 may be corrected by affine transformation. Next, the correction unit 24 corrects distortion of the image Pic2 in the X direction (step S303). Furthermore, the correction unit 24 corrects distortion of the image Pic2 in the Y direction (step S304). Since the corrected Pic2 ideally has the same distortion as Pict, an image analysis, etc. in which Pic1 and Pic2 are superimposed with each other, will not produce any misalignment of the two images (step S305).

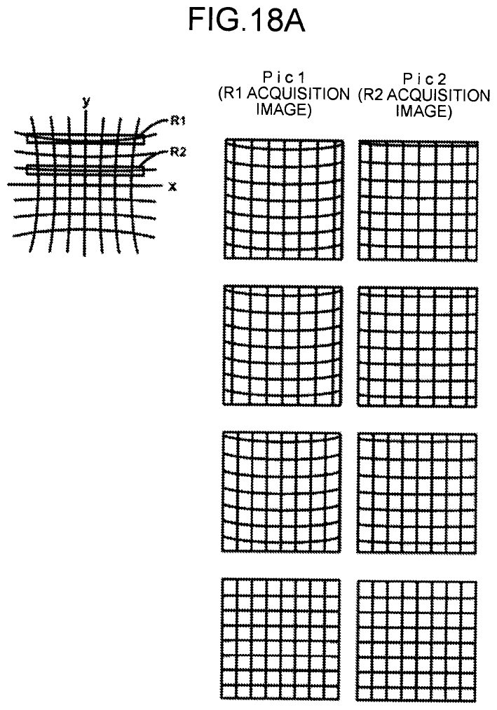

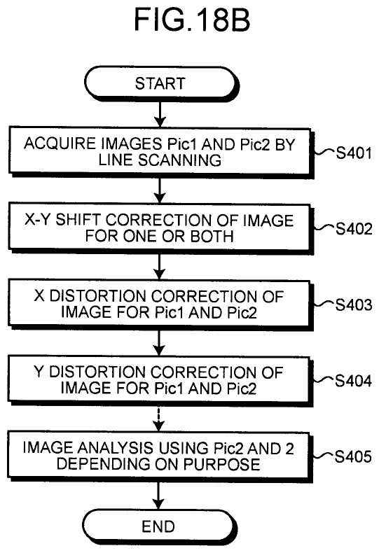

FIGS. 18A and 18B illustrate an example of acquiring and correcting both the acquired image Pic1 and the acquired image Pic2 in order to obtain an ideal image without any inherent distortion. Similarly to FIGS. 16A and 16B, and FIGS. 17A and 17B, an image acquired by line scanning has distortion in both the X direction (extending direction of the line illumination) and the Y direction (scanning direction) (step S401). The correction unit 24 performs shift correction with respect to the X direction and the Y direction of the image in order to adapt one of the acquired images to the other or adapt both images to the ideal state (step S402). At this time, positional shift or the like of the imaging device corresponding to each photographic area may be corrected by affine transformation. Next, the correction unit 24 corrects distortion of Pic1 and Pic2 in the X direction (step S403). Furthermore, the correction unit 24 corrects distortion of the images Pic1 and Pic2 in the Y direction (step S404). Since the corrected Pic1 and Pic2 ideally have no distortion left, an image analysis, etc. in which Pic1 and Pic2 are superimposed with each other, will not produce any misalignment of the two images (step S405).

In the above description, the X-axis distortion correction is performed and then the Y-axis distortion correction is performed, but the processing may be performed in the reverse order. The correction of the X-axis distortion and the correction of the Y-axis distortion may be performed simultaneously.

### 1.7. Display Unit

Next, the display unit 3 will be described.

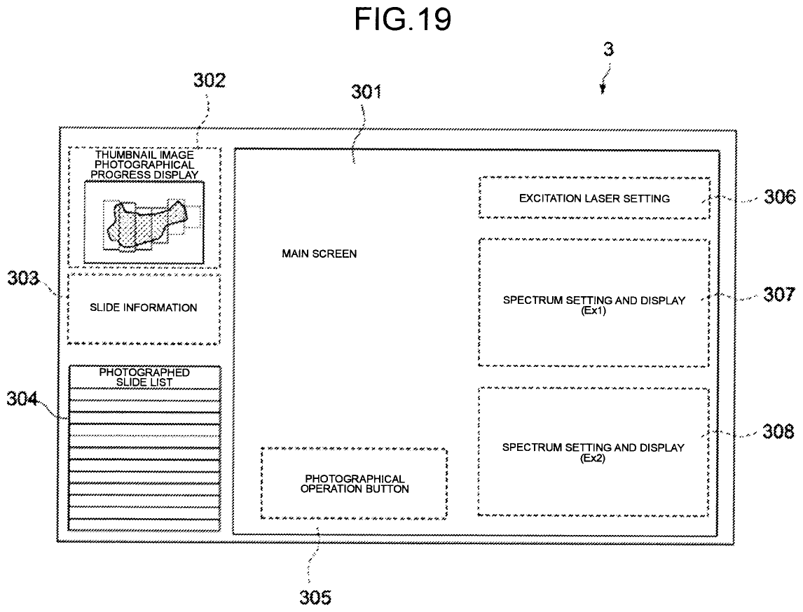

FIG. 19 is a diagram illustrating a screen of the display unit 3. The display unit 3 may be constituted by a monitor integrally attached to the processing unit 2, or may be a display device connected to the processing unit 2. The display unit 3 includes: a display element such as a liquid crystal device or an organic EL device; and a touch sensor. The display unit 3 functions as a user interface (UI) that displays input setting of photographic conditions, photographic images, and the like.

As illustrated in FIG. 19, the display unit 3 includes a main screen 301, a thumbnail image display screen 302, a slide information display screen 303, and a display screen 304 for slide list photographed. The main screen 301 includes regions such as a setting region 305 for photographic operation buttons (keys), a setting region 306 for an excitation laser (excitation unit 10), and setting regions 307 and 308 for detection of fluorescence spectrum originated from the line illuminations Ex1 and Ex2. It is only required to constantly have at least one of these setting regions 305 to 308, and one display region may include another display region.

The fluorescence observation device 100 sequentially performs operations such as extraction of a slide (sample S) from a slide rack (not illustrated), reading of slide information, photographic operation of a thumbnail of the slide, and exposure time settings. Slide information includes patient information, tissue site, disease, staining information, and the like, and is read from a barcode, a QR code (registered trademark), and the like attached to the slide. The thumbnail image and the slide information of the sample S are respectively displayed on the display screens 302 and 303. The display screen 304 displays a list of the photographed slide information.

The main screen 301 displays photographic situation of the slide currently being photographed, in addition to the fluorescence image of the sample S. The excitation laser (line illumination Ex1, Ex2) is displayed or set in the setting region 306. The fluorescence spectrum originated from the excitation laser is displayed or set in the setting regions 307 and 308 for display of detection.

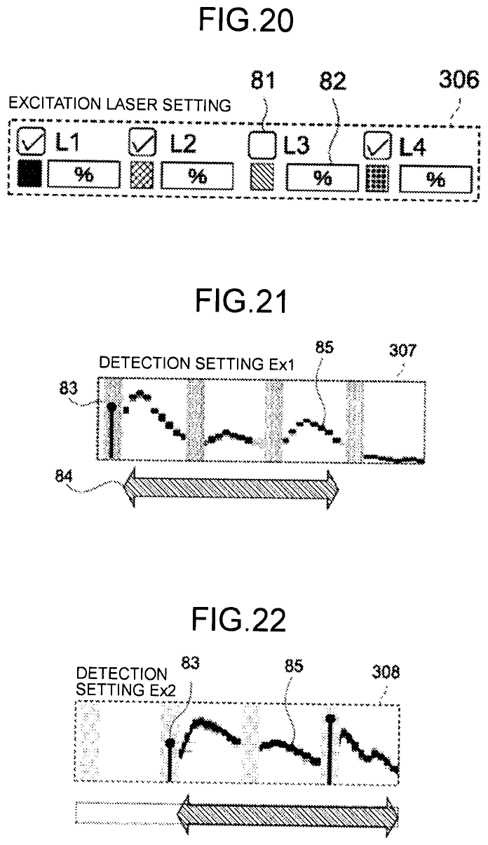

FIG. 20 is a diagram illustrating an example of a screen configuration of the setting region 306 for excitation laser. Here, ON/OFF selection/switching of the output of each of the excitation light sources L1 to L4 is performed by touch operations on a checkbox 81. The magnitude of the output of each light source is set via an operation unit 82. In this example, the line illumination Ext is set to a single wavelength of the excitation light source L1.

FIG. 21 is a diagram illustrating an example of a screen configuration of the setting region 307 for detection of the fluorescence spectrum originated from the line illumination Ex1. FIG. 22 is a diagram illustrating an example of a screen configuration of the setting region 308 for the detection of the fluorescence spectrum originated from the line illumination Ex2. The vertical axis represents luminance, and the horizontal axis represents wavelength.

In FIGS. 21 and 22, an index 83 indicates that the excitation light source (L1, L2, or L4) is turned on, and indicates such that the longer the index 83, the higher the power of the light source. The detection wavelength range of a fluorescence spectrum 85 is set by a setting bar 84.

A method of displaying the fluorescence spectrum 85 is not particularly limited. For example, the fluorescence spectrum is displayed as an entire pixel average spectrum (wavelength×intensity) of the imaging element 32. The fluorescence spectrum 85 can be set in accordance with the wavelength and power of the excitation light source. The fluorescence spectrum 85 is displayed as a waveform calculated by adding a setting change from the current average or the last waveform photographed.

In addition, as illustrated in FIGS. 21 and 22, the fluorescence spectrum 85 may be displayed by a heat map method in which frequency information of values is represented by shading. This makes it possible to visualize the distribution of the signal that is not known by the average value.

Note that the vertical axis of the graph displaying the fluorescence spectrum 85 is not limited to the linear axis, and may be a logarithmic axis or a hybrid axis (bi-exponential axis).

The display unit 3 is configured to be able to display fluorescence spectra separately for individual excitation lines (Ex1 and Ex2). In addition, the display unit 3 includes a UI having an operation region for explicitly displaying the light source wavelength and the power used to irradiate the individual excitation lines. The display unit 3 further includes a UI that displays a detection wavelength range for each fluorescence spectrum. That is, the readout region of the imaging element 32 is configured to change on the basis of the set wavelength range.

With this configuration, it is possible, in the fluorescence observation device of the different axis excitation system, to present photographic conditions clearly to the user. In particular, by providing the setting regions 307 and 308 for detection of the fluorescence spectrum in the display unit 3, the relationship between the excitation line and the excitation wavelength and the relationship between the excitation wavelength and the imaging wavelength range can be displayed clearly even in the case of the off-axis excitation.

The display unit 3 displays the fluorescence image of the sample S output from the image forming unit 23 on the main screen 301. The fluorescence image output from the image forming unit 23 to the display unit 3 is presented to the user in a state of having a corrected value (interval Δy between line illuminations Ex1 and Ex2) corresponding to a difference in detection coordinates between the different-axis slits (the respective slits of the observation slit 31). This makes it possible for the user to recognize the image in which the respective pieces of separate image data are displayed in a multiple manner without being conscious of the difference in the different-axis detection position.

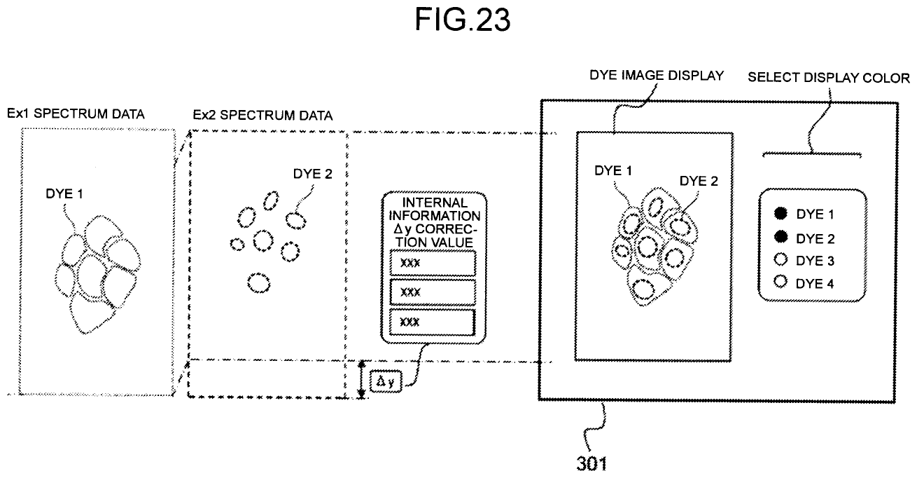

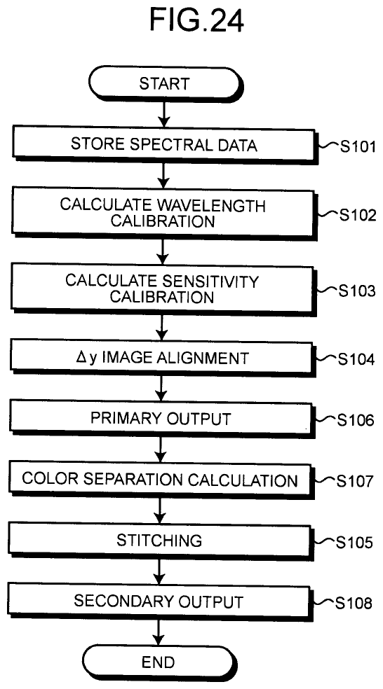

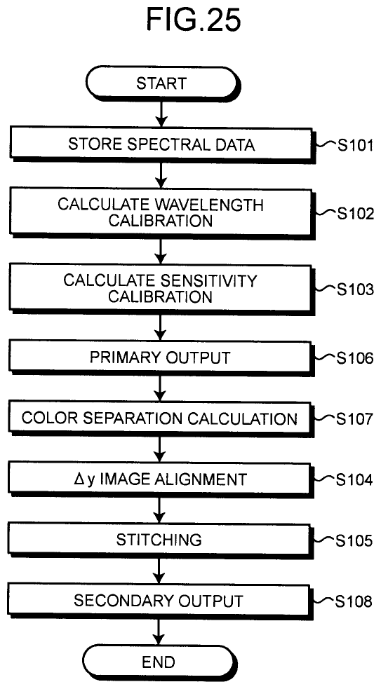

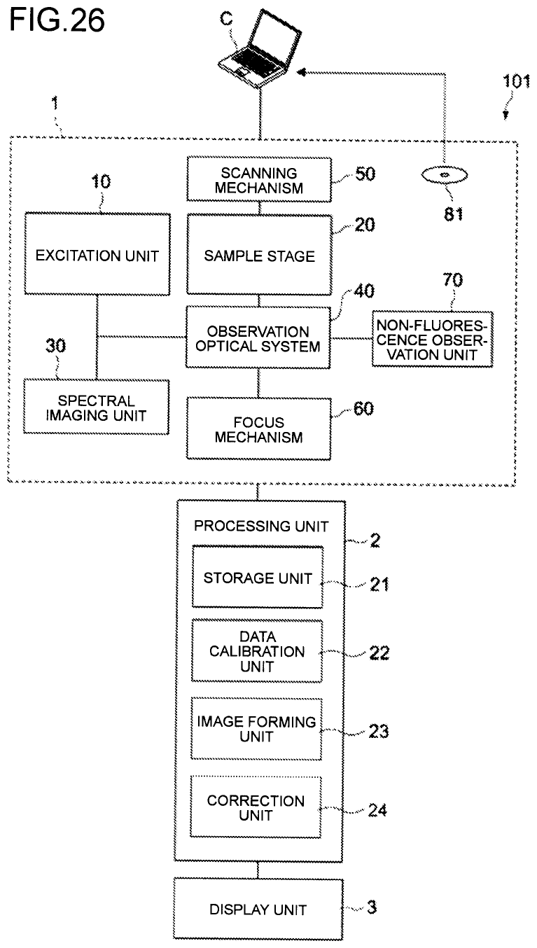

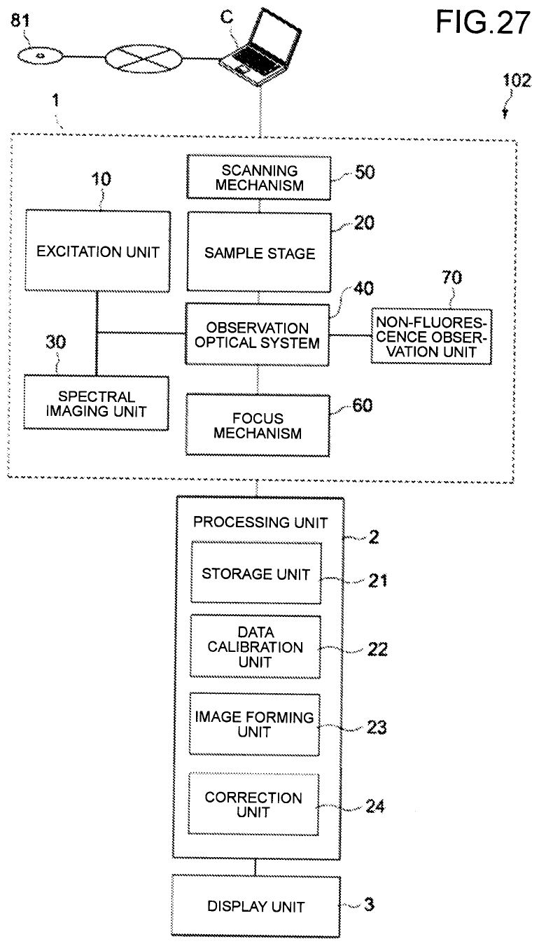

For example, as illustrated in FIG. 23, a plurality of separate images (image related to dye 1 and image related to dye 2) are generated from the spectral data originated from the plurality of line illuminations Ex1 and Ex2, and displayed on the main screen 301 in a state where the respective images are superimposed in different colors. Here, the image related to the dye 1 is superimposed on the image related to the dye 2 by correcting the difference in the Y coordinate corresponding to Δy.

Each of the separate images corresponds to the standard spectrum used for the separation calculation, that is, the dye used for staining. The main screen 301 may display a selection screen for the dye to be displayed in addition to the dye image in which the individual separate images are superimposed. In this case, image display is switched in conjunction with dye selection. When the dye 1 or 2 is selected, only the image corresponding to the selected dye will be displayed as illustrated in FIG. 23.

The correction value of Δy is stored in the storage unit 21 and managed as internal information. The display unit 3 may be configured to be able to display information related to Δy, or may be configured to be able to change the displayed Δy. The correction value (Δy) may include not only the correction value for the distance between the slits (or the interval of the line illumination) but also a distortion amount such as distortion in the optical system. Furthermore, in a case where the spectrum of each dye is detected by a different camera (imaging element), a correction amount related to detection coordinates in the Y-axis direction in each camera may be included.

### 1.8. Verification Result

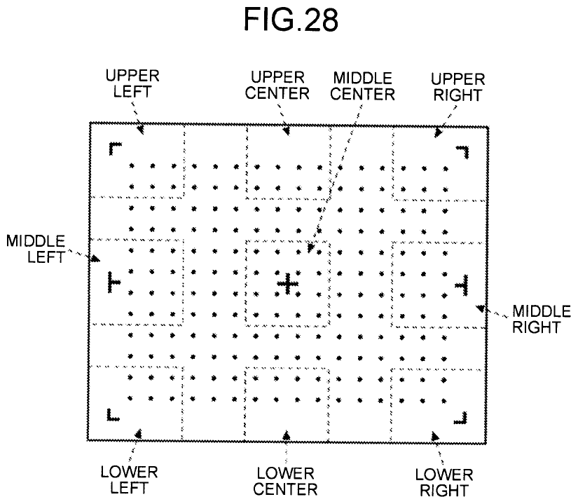

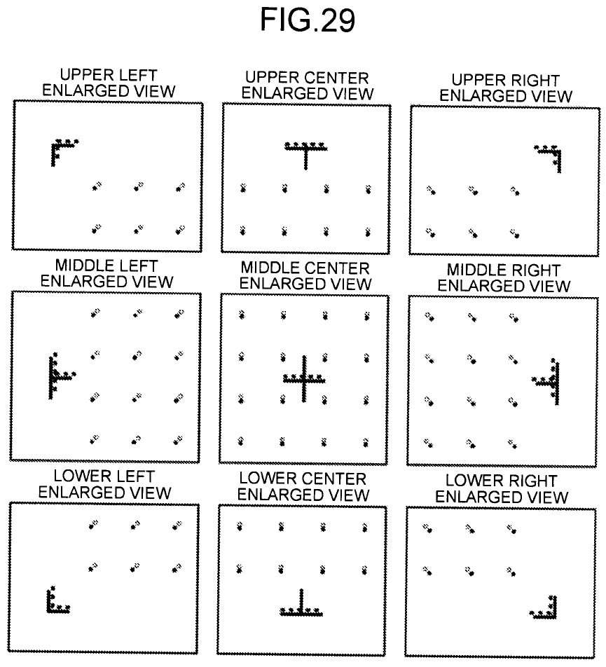

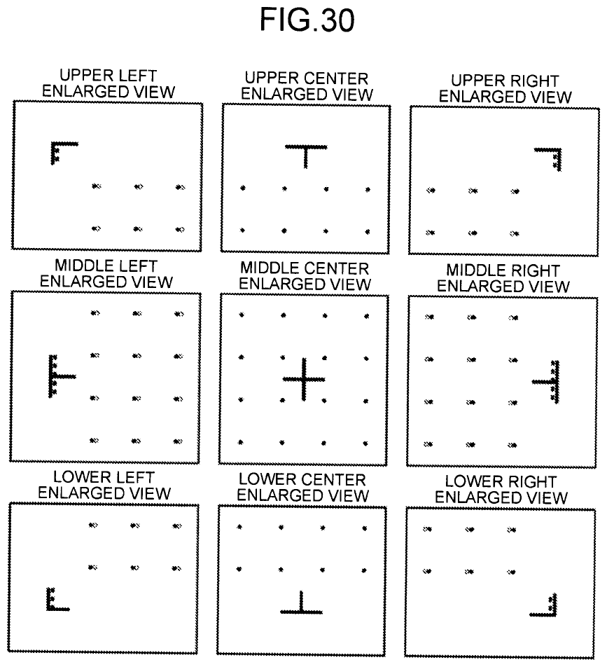

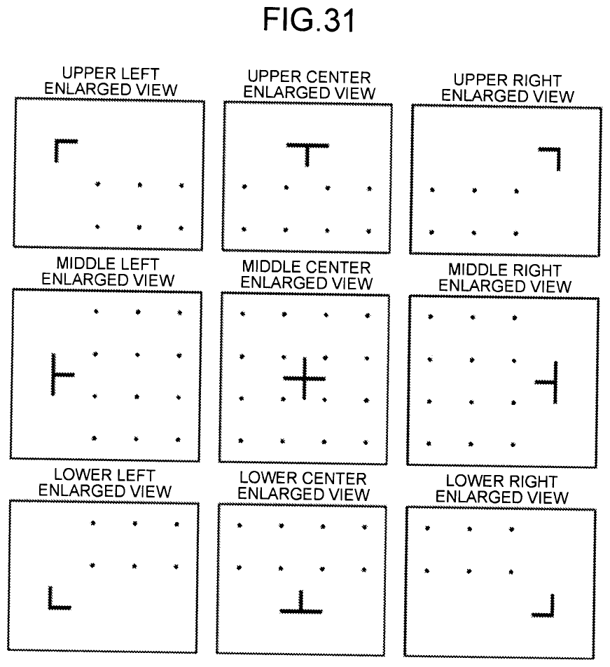

Next, an effect of eliminating distortion by applying the present embodiment will be described by presenting a result of verification using actually imaged test charts. FIG. 28 is a schematic diagram of a test pattern used for verification of an effect according to the present embodiment. FIG. 29 is a schematic diagram illustrating misalignment of two line scan images when the present embodiment is not applied. FIG. 30 is a schematic diagram illustrating misalignment when geometric correction is performed on the two line scan images. FIG. 31 is a schematic diagram illustrating the fact that application of the present embodiment has reduced misalignment of two line scan images.

The test pattern used in this verification was a dot grid pattern as illustrated in FIG. 28. In this test chart, there is a cross pattern at the center, a T-shaped pattern at upper, lower, left, and right ends, and a hook bracket pattern at four corners. By using the above-described embodiment for this test chart, two types of line scan images were acquired. Images were acquired at two different positions in the visual field of the imaging system where line scanning was performed. FIG. 29 illustrates enlarged views of a total of nine positions including the center of the test pattern, upper, lower, left, and right ends, and four corners of the test pattern. One image is indicated by a solid line and a filled circle, the other image is indicated by a broken line and an open circle, with overlapping portions indicated by a solid line and a filled circle. As illustrated in FIG. 29, it can be seen that the two images are misaligned. Here, two types of misalignment are mixed.

The first type of is misalignment expressed by translation or linear transformation, and there is another type of misalignment due to distortion aberration. The first type of misalignment, represented by translation or linear transformation, is due to a positional shift or an inclination shift of the line. In this regard, it is possible to achieve higher consistency by performing geometric correction by affine transformation on one image. FIG. 30 illustrates a state in which the geometric correction by the affine transformation has been actually performed. Although the higher consistency is achieved compared to FIG. 29, there are still low consistency portion remaining at both left and right ends of the screen.

The second type of misalignment due to distortion aberration is distortion generated by the imaging system. FIG. 31 illustrates a result of correcting the quadratic function in the scanning direction and correcting the cubic function in the line direction as described above. As illustrated in FIG. 31, higher consistency can be achieved in the two images by these two types of correction.

As described above, execution of these types of correction on data acquired by line scanning at different visual field positions makes it possible to achieve higher consistency. This makes it possible to perform analysis with higher accuracy when analysis is performed based on a plurality of images. Here, the correction for the line scan image at two different positions in the visual field has been described, although the similar applies to three or more positions in principle.

### 1.9. Modifications

Although the above embodiment is an example in which appropriate distortion correction is performed for each photographic area in the multiple fluorescence scanner, it is also allowable to perform correction of Formula (2) on a single photographic area in a monochromatic fluorescence scanner.

### 1.10. Summary

As described above, according to the present embodiment, it is possible to achieve higher consistency of a plurality of images subjected to line scanning at different positions in the visual field of the imaging system. This leads to further correct execution of analysis based on the plurality of images. For example, in the method described in the present embodiment, line-shaped excitation beams are arranged at different locations in the visual field to generate fluorescence of the sample. Each fluorescence line undergoes spectroscopy to acquire each spectrum. Since the line scan images are obtained at different positions in the visual field, the images have distortions in different ways. Because of this, even data of the same coordinate in the image indicates a different place as the image, leading to a failure in execution of correct spectral analysis. Therefore, by performing the correction according to the present embodiment, it is possible to achieve higher consistency of the two images. That is, the coordinates in the image and the position of the image are matched with each other in each image, the analysis can be performed correctly, and the features of the tissue and the cell can be captured with high accuracy.

The preferred embodiments of the present disclosure have been described in detail above with reference to the accompanying drawings. However, the technical scope of the present disclosure is not limited to such examples. It will be apparent to those skilled in the art of the present disclosure that various modifications and alterations can be conceived within the scope of the technical idea described in the claims and naturally fall within the technical scope of the present disclosure.

The above-described configuration illustrates an example of the present embodiment, and naturally belongs to the technical scope of the present disclosure.

Furthermore, the effects described in the present specification are merely illustrative or exemplary and are not limited. That is, the technology according to the present disclosure can exhibit other effects that are apparent to those skilled in the art from the description of the present specification in addition to or instead of the above effects.

Note that the following configurations also belong to the technical scope of the present disclosure.

(1)

A biological specimen detection system including:
a stage capable of supporting a sample including a biological specimen;
an observation system that includes an objective lens and observes the sample in a line-shaped visual field that is a part of a visual field through the objective lens;
a signal acquisition unit that acquires an image signal obtained from the sample by scanning the observation system in a first direction orthogonal to the line-shaped visual field; and
a correction unit that corrects distortion of a captured image based on the image signal on a basis of a positional relationship between an optical axis center of the objective lens and the line-shaped visual field.
   (2)

The biological specimen detection system according to (1), wherein the correction unit corrects distortion of the captured image further on a basis of optical information of the observation system.

(3)

The biological specimen detection system according to (2), wherein the optical information of the observation system includes at least one of magnification of an imaging unit included in the observation system and information related to scanning of the stage.

(4)

The biological specimen detection system according to any one of (1) to (3),
wherein the observation system includes an irradiation unit that irradiates the sample with a line-shaped beam of light, and scans the line-shaped beam of light in the first direction.
   (5)

The biological specimen detection system according to any one of (1) to (4), wherein the signal acquisition unit generates the captured image by connecting a plurality of region images obtained by imaging the line-shaped visual field during scanning of the observation system.

(6)

The biological specimen detection system according to (5), wherein the observation system generates the plurality of region images by imaging the line-shaped visual field using a sensor including a plurality of pixels arranged in a direction parallel to a scanning plane including the first direction and perpendicular to the first direction.

(7)

The biological specimen detection system according to (6), wherein the signal acquisition unit generates the plurality of region images by clipping a region corresponding to the line-shaped visual field from each of a plurality of pieces of image data obtained by imaging different positions of the sample.

(8)

The biological specimen detection system according to any one of (1) to (7), wherein the correction unit corrects distortion of the captured image on a basis of a position of the line-shaped visual field with respect to an optical axis of the objective lens.

(9)

The biological specimen detection system according to (8), wherein the line-shaped visual field is a rectangular region elongated in a direction perpendicular to the first direction.

(10)

The biological specimen detection system according to any one of (1) to (9), wherein the observation system simultaneously images two or more of the line-shaped visual fields having different positions.

(11)

The biological specimen detection system according to any one of (1) to (10), wherein the signal acquisition unit generates the captured image of the sample as a spectral image.

(12)

The biological specimen detection system according to (11), wherein the signal acquisition unit generates the captured image from the image signal obtained by observing a fluorescence spectrum emitted by irradiation of the sample that is fluorescence-stained, with excitation light.

(13)

The biological specimen detection system according to any one of (1) to (12),
wherein the observation system further includes an irradiation unit that irradiates two or more different positions of the sample with line-shaped beams of light having different wavelengths, and
the observation system simultaneously images the two or more positions irradiated with the line-shaped beams of light having different wavelengths.
   (14)

The biological specimen detection system according to (10), further including an analysis unit that analyzes a substance contained in the sample.

(15)

The biological specimen detection system according to (14), wherein the analysis unit analyzes at least one of: measurement accuracy of the observation system; separation performance in separating a fluorescent component from the captured image; and staining performance of a fluorescent reagent panel used for fluorescent staining of the sample, on a basis of the captured image.

(16)

The biological specimen detection system according to any one of (1) to (15),
wherein, in a case where the line-shaped visual field is located on an x-y plane perpendicular to an optical axis of the objective lens, a y-axis direction of the x-y plane corresponds to the first direction, x is a position on an x axis in an x-y coordinate system with a point intersecting with the optical axis of the objective lens as an origin, y is a position on the y axis in the x-y coordinate system, and c1 to c4 are predetermined coefficients, the correction unit corrects the captured image using the following Formula (4).

x=c₁x′+c₂x′³

y=c₃y′+c₄x′² (4)

(17)

The biological specimen detection system according to (16),
wherein the c1 is a coefficient related to a magnification of the objective lens,
the c2 is a coefficient indicating a degree of distortion of the captured image in an x-axis direction in accordance with a position in the x-axis direction,
the c3 is a coefficient related to stage scanning, and
the c4 is a coefficient indicating a degree of distortion of the captured image in the y-axis direction according to the position in the x-axis direction.
   (18)

The biological specimen detection system according to any one of (1) to (17), wherein the sample is a pathological specimen.

(19)

A microscope system including the biological specimen detection system according to any one of (1) to (18).

(20)

A fluorescence microscope system including:
the microscope system according to (19); and
a light source that irradiates the sample with excitation light.
   (21)

A biological specimen detection method including:
generating a captured image of a sample including a biological specimen from an image signal obtained by capturing an image of the sample in a line-shaped visual field that is a part of a visual field through an objective lens while temporally changing relative positions of the sample and the objective lens in a first direction; and
correcting distortion of the captured image in accordance with a positional relationship between the objective lens and the line-shaped visual field.
   (22)

A program for causing a processor mounted on an information processing device to function, the program provided to cause the processor to execute processes including:
a process of generating a captured image of a sample including a biological specimen from an image signal obtained by capturing an image of the sample in a line-shaped visual field that is a part of a visual field through an objective lens while temporally changing relative positions of the sample and the objective lens in a first direction; and
a process of correcting distortion of the captured image in accordance with a positional relationship between the objective lens and the line-shaped visual field.

### REFERENCE SIGNS LIST

1 OBSERVATION UNIT
2 PROCESSING UNIT
3 DISPLAY UNIT
10 EXCITATION UNIT
20 STAGE
21 STORAGE UNIT
22 DATA CALIBRATION UNIT
23 IMAGE FORMING UNIT
30, 130 SPECTRAL IMAGING UNIT
32, 32a, 32b IMAGING ELEMENT
35 DIFFRACTION GRATING
38 WAVELENGTH DISTRIBUTION ELEMENT
50 SCANNING MECHANISM
70 NON-FLUORESCENCE OBSERVATION UNIT
80 CONTROL UNIT
81 CHECK BOX
100 FLUORESCENCE OBSERVATION DEVICE
Ex1, Ex2 LINE ILLUMINATION
S SAMPLE

1. A biological specimen detection system including:
a stage capable of supporting a sample including a biological specimen;
an observation system that includes an objective lens and observes the sample in a line-shaped visual field that is a part of a visual field through the objective lens;
a signal acquisition unit that acquires an image signal obtained from the sample by scanning the observation system in a first direction orthogonal to the line-shaped visual field; and
a correction unit that corrects distortion of a captured image based on the image signal on a basis of a positional relationship between an optical axis center of the objective lens and the line-shaped visual field.

2. The biological specimen detection system according to claim 1, wherein the correction unit corrects distortion of the captured image further on a basis of optical information of the observation system.

3. The biological specimen detection system according to claim 2, wherein the optical information of the observation system includes at least one of magnification of an imaging unit included in the observation system and information related to scanning of the stage.

4. The biological specimen detection system according to claim 1,
wherein the observation system includes an irradiation unit that irradiates the sample with a line-shaped beam of light, and scans the line-shaped beam of light in the first direction.

5. The biological specimen detection system according to claim 1, wherein the signal acquisition unit generates the captured image by connecting a plurality of region images obtained by imaging the line-shaped visual field during scanning of the observation system.

6. The biological specimen detection system according to claim 5, wherein the observation system generates the plurality of region images by imaging the line-shaped visual field using a sensor including a plurality of pixels arranged in a direction parallel to a scanning plane including the first direction and perpendicular to the first direction.

7. The biological specimen detection system according to claim 6, wherein the signal acquisition unit generates the plurality of region images by clipping a region corresponding to the line-shaped visual field from each of a plurality of pieces of image data obtained by imaging different positions of the sample.

8. The biological specimen detection system according to claim 1, wherein the correction unit corrects distortion of the captured image on a basis of a position of the line-shaped visual field with respect to an optical axis of the objective lens.

9. The biological specimen detection system according to claim 1, wherein the line-shaped visual field is a rectangular region elongated in a direction perpendicular to the first direction.

10. The biological specimen detection system according to claim 1, wherein the observation system simultaneously images two or more of the line-shaped visual fields having different positions.

11. The biological specimen detection system according to claim 1, wherein the signal acquisition unit generates the captured image of the sample as a spectral image.

12. The biological specimen detection system according to claim 11, wherein the signal acquisition unit generates the captured image from the image signal obtained by observing a fluorescence spectrum emitted by irradiation of the sample that is fluorescence-stained, with excitation light.

13. The biological specimen detection system according to claim 1,
wherein the observation system further includes an irradiation unit that irradiates two or more different positions of the sample with line-shaped beams of light having different wavelengths, and
the observation system simultaneously images the two or more positions irradiated with the line-shaped beams of light having different wavelengths.

14. The biological specimen detection system according to claim 10, further including an analysis unit that analyzes a substance contained in the sample.

15. The biological specimen detection system according to claim 14, wherein the analysis unit analyzes at least one of: measurement accuracy of the observation system; separation performance in separating a fluorescent component from the captured image; and staining performance of a fluorescent reagent panel used for fluorescent staining of the sample, on a basis of the captured image.

16. The biological specimen detection system according to claim 1,
wherein, in a case where the line-shaped visual field is located on an x-y plane perpendicular to an optical axis of the objective lens, a y-axis direction of the x-y plane corresponds to the first direction, x is a position on an x axis in an x-y coordinate system with a point intersecting with the optical axis of the objective lens as an origin, y is a position on the y axis in the x-y coordinate system, and c1 to c4 are predetermined coefficients, the correction unit corrects the captured image using the following Formula (1).
x=c₁x′+c₂x′³
y=c₃y′+c₄x′² (1)

17. The biological specimen detection system according to claim 16,
wherein the c1 is a coefficient related to a magnification of the objective lens,
the c2 is a coefficient indicating a degree of distortion of the captured image in an x-axis direction in accordance with a position in the x-axis direction,
the c3 is a coefficient related to stage scanning, and
the c4 is a coefficient indicating a degree of distortion of the captured image in the y-axis direction according to the position in the x-axis direction.

18. The biological specimen detection system according to claim 1, wherein the sample is a pathological specimen.

19. A microscope system including the biological specimen detection system according to claim 1.

20. A fluorescence microscope system including:
the microscope system according to claim 19; and
a light source that irradiates the sample with excitation light.

21. A biological specimen detection method including:
generating a captured image of a sample including a biological specimen from an image signal obtained by capturing an image of the sample in a line-shaped visual field that is a part of a visual field through an objective lens while temporally changing relative positions of the sample and the objective lens in a first direction; and
correcting distortion of the captured image in accordance with a positional relationship between the objective lens and the line-shaped visual field.

22. A program for causing a processor mounted on an information processing device to function, the program provided to cause the processor to execute processes including:
a process of generating a captured image of a sample including a biological specimen from an image signal obtained by capturing an image of the sample in a line-shaped visual field that is a part of a visual field through an objective lens while temporally changing relative positions of the sample and the objective lens in a first direction; and
a process of correcting distortion of the captured image in accordance with a positional relationship between the objective lens and the line-shaped visual field.
